(19) United States
(12) Patent Application Publication
(10) Pub. No.: US 2006/0282286 A1
(43) Pub. Date: Dec. 14, 2006

(54) Evidence-based quality improvement and risk management solutions method

(76) Inventors: Stephen J. Faris III, Nashville, TN (US); Srinivasalu Ambati, Ashland, MA (US); Robert De Vivo, Belmont, MA (US); William Reece, Boston, MA (US); Skye Schulte, Somerville, MA (US); Karen McCloskey, Littleton, MA (US); Richard Glickman-Simon, Sudbury, MA (US)

Correspondence Address: FISH & RICHARDSON PC, P.O. BOX 1022, MINNEAPOLIS, MN, 55440-1022, US

(21) Appl. No.: 11/152,809

(22) Filed: Jun. 14, 2005

(51) Int. Cl. G06Q 10/00; G06N 5/00

(52) U.S. Cl. 705/2; 706/45

(57) ABSTRACT

A computer-implemented method includes determining a set of related medical activities based on received medical evidence, providing a set of tools, each tool corresponding to at least one of the related medical activities in the set, identifying a set of content blocks in each tool in the set of tools, including identifying content blocks that can be common to at least two tools, determining a medical condition of a patient, and selecting a first tool from the set of tools based on the medical condition.

### BACKGROUND

The present invention relates to data processing by digital computer, and more particularly to evidence-based quality improvement and risk management.

A key to success for any hospital is to bring patients in for services, keep them safe while under care, discharge them in better health, and have them return to the facility whenever the future need arises. Information tools can help save money, decrease practice variability and improve patient care and satisfaction.

Health Plans are looking to reduce costs and claims, decrease the variability in patient care, and improve member satisfaction and health outcomes. An integration of information solutions and tools can facilitate informed decision-making for both physicians and patients using evidence and best practices in medicine.

Delivering high quality, timely, and cost-effective care to patients can be challenging without the right information and tools. Evidence-based medicine information tools can help organizations achieve their quality initiatives, save money, and reduce risk and liability. Evidence-based medicine is the conscientious, explicit, and judicious use of current best evidence in making decisions about the care of individual patients. The practice of evidence-based medicine means integrating individual clinical expertise with the best available external clinical evidence from systematic research.

### SUMMARY

The present invention provides methods and apparatus, including computer program products, for evidence-based quality improvement and risk management solutions.

In general, in one aspect, the invention features a computer-implemented method including determining a set of related medical activities based on received medical evidence, providing a set of tools, each tool corresponding to at least one of the related medical activities in the set, identifying a set of content blocks in each tool in the set of tools, including identifying content blocks that can be common to at least two tools, determining a medical condition of a patient, and selecting a first tool from the set of tools based on the medical condition.

In embodiments, the method can include updating the first tool in conjunction with one or more other tools, the update occurring in at least one content block. Updating can occur in a content block common to at least two tools.

The medical evidence can include literature searches, medical knowledge of medical research journals, medical discoveries, and medical research reports. Providing a set of tools can include selecting a study medical condition, selecting expert medical evidence for the study medical condition, providing medical studies based on the selected expert medical evidence, grading the medical studies, and determining a tool for the study medical condition based on the highest graded medical studies.

Providing a set of tools can include determining national authoritative healthcare quality measures, determining a set of healthcare quality initiatives at a point of care, comparing the set of healthcare quality initiatives with the national authoritative healthcare quality measures, determining a quality of healthcare at the point of care based on comparing, and determining activities to improve the quality of healthcare at the point of care based on comparing.

The set of tools can include medical guidelines and recommendations, decision trees, and/or point of care tools. Clinical point of care tools can include order sets, admission and discharge instructions, patient safety checklists, patient education materials, and/or clinical guidelines.

Identifying content blocks can include linking each content block to documents in the document set that relate to the content block. Linking to documents can include linking each content block to other content blocks that relate to the content block.

Updating the content block can include examining the content of all related content blocks in all related documents. Updating the content block can include keeping the original content block, adding the update to the original content block, and providing the content block as a version of the content block including the original content block and the update.

The invention can be implemented to realize one or more of the following advantages. The method improves quality of care, patient safety, risk management and financial performance by delivering complete evidence-based quality improvement solutions, from planning and design to implementation, at the point of care. The method enables design of a customized quality program built on a foundation of the best clinical evidence available.

The method includes a thorough interview and evaluation process designed to identify areas for quality improvement. From this information, a comprehensive, customized blueprint and action plan are generated to target those areas and provide evidence-based tools, resources and information for the point of care and to help meet various national quality improvement standards and recommendations.

The method includes various components such as a blueprint, clinical reference foundation, clinical toolbox and patient education toolbox as well as content management system for editing, tracking, and versioning the various components. The blueprint enables customized recommendations on how to best implement quality improvement initiatives to meet the organization's unique needs.

The clinical reference foundation is a collection of core materials for specific diseases and conditions including comprehensive evidence-based clinical guidelines, quality measures, decision support tools such as decision trees and clinical indicators, and a summary of filtered and relevant medical literature and its impact on medical practice.

The clinical toolbox provides relevant clinical tools that enable healthcare organizations to generate their own customized quality program. These tools include order sets, error prevention and safety checklists, discharge instructions and other point of care tools. Templates for cost effective data collection are included to help organizations meet the various reporting demands of, for example, the Joint Commission on Accreditation of Healthcare Organizations (JCAHO), National Quality Forum (NQF), the Leapfrog Group (an initiative driven by organizations that buy healthcare who are working to initiate breakthrough improvements in the safety, quality and affordability of healthcare for Americans) and other organizations.

The patient education toolbox includes interactive educational modules that inform and involve patients in the decision-making process in preparation for an upcoming procedure, as well as customizable patient education materials templates, and patient versions of the evidence-based guidelines to improve patient satisfaction at the point of care and across the care continuum.

The method is hosted in an environment to ensure data integrity and provide the latest available information to users. The forms, tools, and evidence-based medicine guidelines may be viewed through a centrally hosted Web site, downloaded to a host on an Intranet, loaded into another healthcare information technology application (e.g., electronic medical records), or transferred to another vendor for printing.

One implementation of the invention provides all of the above advantages.

The details of one or more implementations of the invention are set forth in the accompanying drawings and the description below. Further features, aspects, and advantages of the invention will become apparent from the description, the drawings, and the claims.

### DESCRIPTION OF DRAWINGS

FIG. 1 is a block diagram of an exemplary network.

FIG. 2. is a flowchart of a process.

FIG. 3 illustrates an exemplary database.

FIG. 4. is a flowchart of a process.

Like reference numbers and designations in the various drawings indicate like elements.

### DETAILED DESCRIPTION

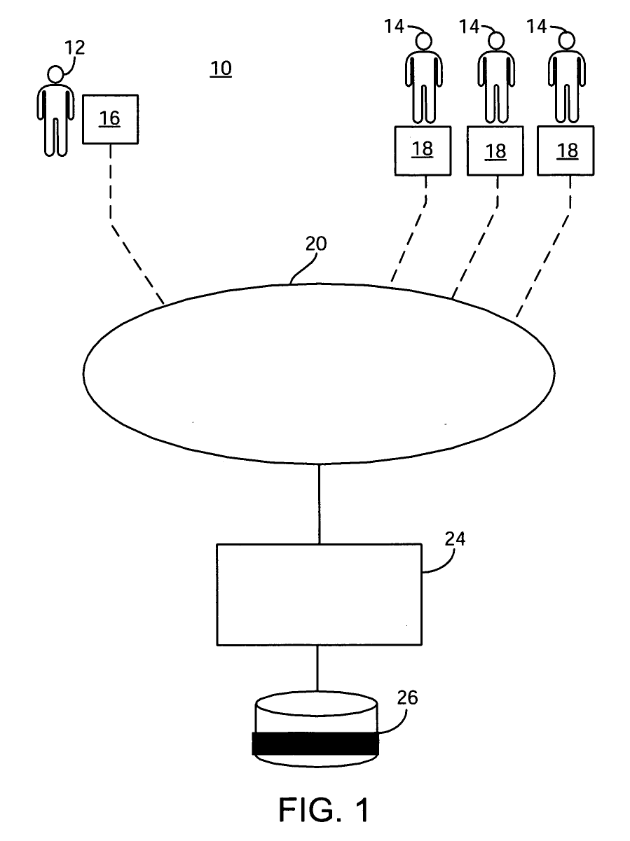

As shown in FIG. 1, an exemplary network 10 includes a user communication device 16, medical expert communication devices 18 and server 24, linked to a communication network 20. The network 10 enables a user 12, such as a healthcare provider, to render high quality medical services supported by a community of experts 14, such as medical experts. The healthcare provider 12 uses the communication device 16 to retrieve qualified medical information in order to guide his/her activity. The medical experts 14 use communication devices 18 to confer and provide medical expertise to the healthcare provider 12. Medical expertise is organized and stored in an exemplary medical database 26 and accessed through the server 24. The communication network 20 and the devices 16, 18 may accommodate a range of communication technologies that provide both local and remote, wireline and mobile wireless access to the server 24. Neither the healthcare provider 12 nor the medical experts 14 are restricted to a physical location in their activities. The healthcare provider 12 and the experts 14 can exchange roles, i.e. in one particular instance one of the experts 14 is the user 12, while in another instance the user 12 is one of the experts 14. For example, a group of medical experts 14, consultant experts and author experts, can be organized by an organization dedicated to provide quality healthcare expertise, while another group of experts 14, provider experts, conduct their activity at a point of care (POC), such as a hospital, where they may also play the role of the user 12.

Two processes 50 and 70, described below, run on network 10. A simultaneity of the processes 50 and 70 insures that current relevant medical research reaches the healthcare provider 12, at a POC, such as a hospital, as soon as the research is qualified by the medical experts 14 as appropriate and practicable. The two processes 50 and 70 update permanently the exemplary medical database 26 with medical knowledge generated by the research of medical experts 14, such as the consultant experts, and the growing expertise of practitioners, such as the provider experts and user 12 in a hospital. In a particular example, medical experts 14, such as the author experts, work with the consultant experts, leading doctors in clinics and administration of leading institutions, such as Duke University Medical Center, Emory Healthcare, Vanderbilt University Medical Center and so forth. The medical experts 14 are permanently engaged in researching the literature and conducting medical research, and as such they address the newest medical evidence immediately.

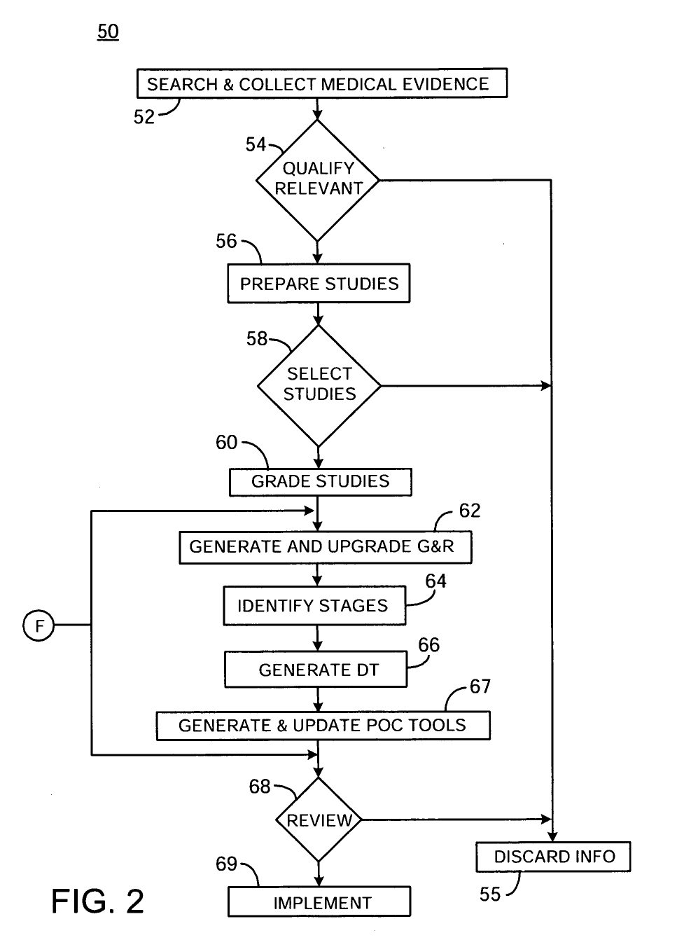

As shown in FIG. 2, process 50 coordinates research of medical evidence in order to provide medical expertise in a structured form. The medical expertise is structured such that it enables the user 12 to use it in an accurate and efficient manner.

The medical experts 14, such as the consultant experts, search and collect (52) available medical evidence from both the latest domestic and international medical publications. Such publications can include books, medical journals or research reports issued by groups known to advance in certain medical research areas. The medical experts 14 discuss medical topics and determine which medical conditions to research. For prioritized medical conditions, the medical experts 14 determine a set of search parameters. In order to search and collect available medical evidence, the medical experts 14 may use dedicated personnel, such as medical librarians. A new search may be started based on a schedule, for example, every week or when the medical experts 14 determine that a certain condition needs emergency research. Alternatively, any of the medical experts 14 may discover new evidence and bring it to the attention of the other members of the expert community, any time. Through cooperation, the medical experts 14 explore all available medical evidence and react quickly to the newest discoveries.

The medical experts 14 qualify (54) the collected medical evidence. First, medical librarians may discard (55) the results of the search that are not related to the researched condition. The medical experts 14 consider only relevant evidence that they determine to be valuable and practicable in providing quality healthcare.

Based on the selected relevant evidence, medical experts 14, such as the consultant experts prepare (56) studies regarding medical conditions. For example, a medical expert designated as consultant expert is assigned to process all the collected relevant new evidence related to a particular medical condition and prepare a study of the particular medical condition. The author expert prepares a list of studies from the new research. The list may include studies of different conditions, as well as studies that are related to the same condition. During a time interval, for example a month, one may accumulate a set of studies related to the same medical condition. Also, studies sourced in the process 70 by medical experts 14 in a hospital may be added on the list of studies of a certain condition.

The medical experts 14, such as the consultant experts, select (58) the studies that may contribute to an improvement of the healthcare regarding the researched conditions. The redundant and non relevant studies are discarded (59).

The medical experts 14, such as the consultant experts, grade (60) the relevant studies of medical conditions. For example, a two-axis scale grading may be used. In this example, on one axis a study may be graded according to its strength of evidence and methodological quality. On the other axis, a risk-benefit grading may indicate if the benefits outweigh the risks. The studies may also be graded from the point of view of the practice impact. A study graded as “high impact study” indicates that the study should result in a change in applying healthcare and an update of related documents and/or clinical tools.

Using qualified medical evidence from the graded studies, the medical experts 14, such as the consultant experts, generate, review and update (62) guidelines and recommendations (G & R) for medical, clinical and administrative activities. To generate, review and update (62) G & R, the consultant experts may use national practice guidelines, such as American College of Cardiology guidelines. If the medical evidence of the graded studies refers to a medical condition not currently in the database, G & R are generated. If the graded studies are related to medical conditions currently in the database, G & R may be updated to reflect new aspects of the medical condition. The consultant experts may generate or update G & R based on feedback from medical experts 14 of a hospital, if the feedback is relevant to the scope of G & R.

The medical experts 14, such as the consultant experts, use the guidelines and recommendations to identify (64) stages of applying medical healthcare for a certain medical condition.

Further, the consultant experts generate (66) a set of decision trees (DT) that guide the user 12, in certain stages of applying healthcare. For example, a DT may guide the user 12 to determine if a patient needs to be admitted in the hospital in order to treat his/her medical condition.

To assist the user 12 in applying the recommended healthcare efficiently at a POC, the medical experts 14, such as the consultant experts, generate and update (67) a set of POC tools. A certain POC tool may support activities in one or more stages of applying healthcare to a patient. POC tools include, but are not limited to, standard order sets, admission and discharge criteria, patient safety checklists, clinical indicators, patient education materials and discharge instructions. As additional medical conditions are researched, new POC tools are generated. Existing POC tools may need to be updated to correspond to new relevant studies. Also, new POC tools generated in process 70 need to be reviewed.

The medical experts 14, such as the author experts, develop a set of quality measures and benchmarking tools. The quality measures and benchmarking tools may be reviewed by the consultant experts. A quality measure determines a level of medical care quality in a stage of applying medical healthcare, specific to a medical condition. The medical experts 14 integrate the set of quality measures and the corresponding benchmarking tools with the G & R, DT and the POC tools.

A group of medical experts 14, such as the provider experts, for example, members of a Medical Committee in a hospital, review and select (68) medical evidence in the form of G & R, DT and POC tools that best suit specific conditions at the POC. For example, the geographical location of a certain institution, patient population demographics, and/or patient insurance coverage, may determine the selection of particular G & R, DT and POC tools. The consultant experts cooperate with medical the provider experts at a POC, to select the relevant medical expertise that best apply at the POC. The medical experts 14 execute surveys and interviews to determine the specific level of quality in different stages of applying healthcare, in different medical conditions. The interviews at the POC are executed at different levels of a medical hierarchy, from nurses to local leading medical experts as well as healthcare organization executives. The medical experts 14 determine the level of quality in applying healthcare at the POC, for example, by investigating the POC quality initiatives and POC projects aimed to improve the POC healthcare quality. The POC quality initiatives are analyzed in relation to the quality measures previously integrated with the G & R, DT and the POC tools. The results of such analysis may indicate that new quality initiatives are necessary in some stages of applying healthcare at that POC. The POC quality levels, derived from the quality measures, are compared with standard, nationally benchmarked quality levels. Based on the results of the comparison, the medical experts 14 advise the selection of those G & R, DT and POC tools that are expected to raise the healthcare quality level at the POC. In some cases, the medical experts 14 may decide to generate new G & R, DT or POC tools in order to match the national quality measures. The provider experts may review feedback from process 70 in order to select POC tools, originated or updated at the POC, which qualify to be integrated in the general practice of applying health care.

The medical experts 14 at the POC implement (69) the selected G & R, DT and POC tools at the POC, for example, in a hospital. The implementation of the G & R, DT and the POC tools at a POC includes either updating existing evidence in the database 26 or creating a new database 26.

Process 50 provides continuously the newest relevant medical evidence at a POC, based both on the latest medical research and feedback from the POC. By integrating the POC feedback and constantly providing updates, the healthcare quality is continuously and uniformly increased in POCs. The frequency of updating the database 26 may vary depending on the volume of the information rendered by the medical research. Alternatively, the generation of the G & R, DTs and POC tools and the integration of the quality measures may be executed on a fixed schedule. In either alternative, fresh updates of the G & R, DT and POC tools are implemented (69) periodically at the POC, in the database 26.

Part of implementing (69) the G & R, DTs and POC tools is structuring the database 26. Database 26 is structured by determining content blocks. Content blocks are building blocks of the database 26. A content block includes information common across different G & R, DTs and POC tools implemented in the database 26. The content blocks may belong to different G & R or DTs that apply to different medical conditions, or they may occur as common routines of different POC tools. Once common content blocks are identified, only one single instance of each common block is stored and maintained in the database 26.

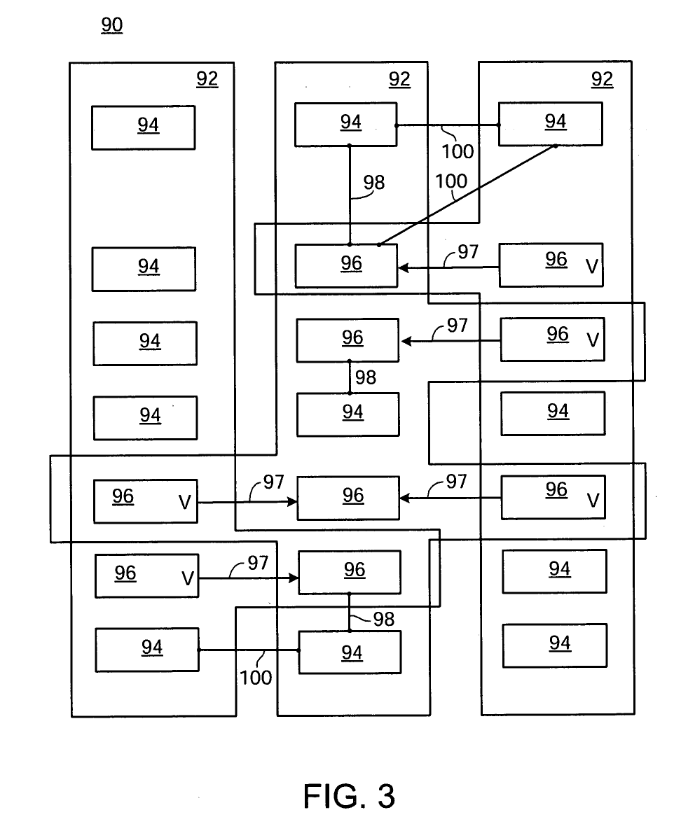

Referring to FIG. 3, the database 26 has a logical structure 90, such that each G & R, DT and POC tool 92 includes specific content blocks 94 and common content blocks 96. A single physical copy of common content blocks 96 is stored. The content blocks marked “96 V” refer to the same content as the content stored in a content block 96. Here the letter “V” signifies “virtual.” The virtual content blocks 96 V contain pointers 97 to a unique copy of a common content block 96. The content blocks 94, 96 may be related. For example, content blocks 94, 96 may characterize aspects of a singular G & R. When an update is executed, one determines related content blocks and links them through relating links. Relating links may be established between content blocks of the same G & R, DT or POC tool 98, or between content blocks of different G & R, DT or POC tools 100. An update of a common content block 96 is propagated to all the related POC tools. To keep an update local to a certain POC tool, a specific content block 94 is updated in that POC tool.

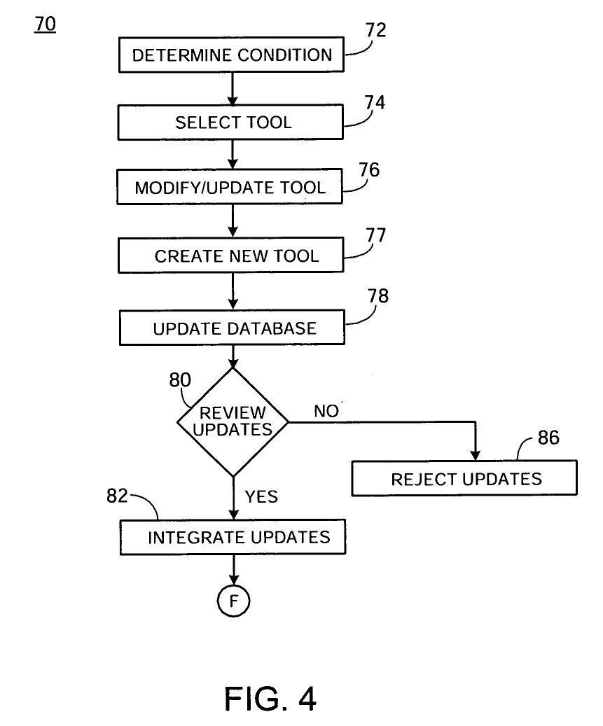

As shown in FIG. 4, process 70 guides the user 12 to deliver high quality healthcare using a structured form of evidence-based medical expertise from the database 26, continuously updated according to the latest medical research and national quality measures.

The healthcare provider user 12 determines (72) a medical condition of a patient. To determine (72) the patient's medical condition, the user 12 may access the database 26 in order to inspect medical evidence, for example, G & R and/or DTs.

Based on the medical condition of the patient, the user 12 selects (74) a POC tool. For example, an admission order set related to the medical condition of the patient can be selected (74). At different stages of applying healthcare related to the patient's medical condition, the user 12 uses different POC tools to guide his/her activities. One specific POC tool may be useful in several stages of applying healthcare and some stages may be supported by more than one POC tool.

Following through the stages of applying healthcare for the determined condition, the user 12 may determine that specific local conditions have an impact on a POC tool retrieved from the database 26. The user 12, who in some instances may be one of the medical experts 14, may decide that he/she needs to modify or update (76) the POC tool. Typically, the modifications of the POC tools by user 12 reflect local POC variations in work flow, drug formularies and medical staff preferences, within a frame outlined by the G & R and DTs. When the user 12 modifies a tool, he/she uses a template. Templates are structural elements that contain POC specific and fixed elements, such as logos, headers and footers with standardized instruction text, and tables in standardized formats. The templates render a unitary aspect to the POC tools and control variations in POC tool form layouts. The modifiable content of a tool appears within the frame of a template. After the initial implementation, the templates are rarely changed. The user 12 can change content that is modifiable. For example, the user 12 may want to add an aspect of the patient condition that qualifies the patient to be admitted, an aspect that is not mentioned in a admission order set.

At the POC, the medical experts 14 and user 12 may create (77) new POC tools. For example, new POC tools created at the POC may be related to activities in the Intensive Care Units (ICUs) and Critical Care Units (CUCs) or co-morbid conditions.

As the user 12 modifies or creates a new POC tool, he/she modifies or adds content blocks in the database 26, blocks related to the modified or new POC tool. Thus the user 12 implicitly updates (78) the database 26. The update does not remove any of the medical evidence already present in POC tools. A POC tool is updated by creating a new version of the selected content block. The new version of the content block is stored on top of older versions of the content block. Each time an update occurs in a content block, the new version of the content block is stored without modifying the older versions. This way, a history of the development of the POC tool is completely preserved. Having the history of the POC tool development available enables the user 12 and medical experts 14 to review the POC tool efficiently. Once executed, the update is immediately available, in the database 26, to the medical experts 14 and users 12 at the POC, for example in a certain hospital. If the updated content block is a common content block, all the related POC tools are updated, as well.

When the user 12 uses a tool stored in the database 26 and examines a content block linked to related content blocks by relating links 98 or 100, the related content blocks can be seen. In this manner, the user 12 is given all the related evidence and/or quality measures when examining, for example, a specific physician order. Also, when the user 12 examines a content block, he/she can see the older versions of the content block in order to understand the reason, time and source of a certain modification.

Updated content blocks show the updates that user 12 and/or medical experts 14 added to the medical evidence stored in the database 26 in order to customize the POC environment. The updates add information and explain the particularity of the updates. Medical experts 14, such as provider experts of a Medical Committee in a hospital, periodically review (80) the updates entered in the database 26. The provider experts, confer/consult with each other and can decide to integrate (82) the updates or reject (86) the updates. The integration (82) is immediate in that it does not imply a separate document be created or merged. In an updated content block, all its versions are temporarily available while updating. Thus, the updates can be reviewed by simply keeping the versions that are approved and remove the versions that are rejected (86). When a certain update is integrated (82) at the POC, the update is feedback (F) to the process 50, where it is further examined, qualified and integrated for general availability at the POC and to the writer and/or consultant experts.

The invention can be implemented in digital electronic circuitry, or in computer hardware, firmware, software, or in combinations of them. The invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A computer-implemented method comprising:
determining a set of related medical activities based on received medical evidence;
providing a set of tools, each tool corresponding to at least one of the related medical activities in the set;
identifying a set of content blocks in each tool in the set of tools, including identifying content blocks that are common to at least two tools;
determining a medical condition of a patient; and
selecting a first tool from the set of tools based on the medical condition.

2. The method of claim 1 further comprising updating the first tool in conjunction with one or more other tools, the update occurring in at least one content block.

3. The method of claim 2 wherein the updating occurs in a content block common to at least two tools.

4. The method of claim 1 wherein the medical evidence includes literature searches, medical knowledge of medical research journals, medical discoveries, and medical research reports.

5. The method of claim 1 wherein providing a set of tools comprises:
selecting a study medical condition;
selecting expert medical evidence for the study medical condition;
providing medical studies based on the selected expert medical evidence;
grading the medical studies; and
determining a tool for the study medical condition based on the highest graded medical studies.

6. The method of claim 1 wherein providing a set of tools comprises:
determining national authoritative healthcare quality measures;
determining a set of healthcare quality initiatives at a point of care;
comparing the set of healthcare quality initiatives with the national authoritative healthcare quality measures;
determining a quality of healthcare at the point of care based on comparing; and
determining activities to improve the quality of healthcare at the point of care based on comparing.

7. The method of claim 1 wherein the set of tools includes medical guidelines and recommendations.

8. The method of claim 1 wherein the set of tools includes decision trees.

9. The method of claim 1 wherein the set of tools includes point of care tools.

10. The method of claim 9 wherein clinical point of care tools include order sets.

11. The method of claim 9 wherein clinical point of care tools include admission and discharge instructions.

12. The method of claim 9 wherein clinical point of care tools include patient safety checklists.

13. The method of claim 9 wherein clinical point of care tools include patient education materials.

14. The method of claim 9 wherein clinical point of care tools include clinical guidelines.

15. The method of claim 1 wherein identifying content blocks comprises linking each content block to documents in the document set that relate to the content block.

16. The method of claim 13 wherein linking to documents comprises linking each content block to other content blocks that relate to the content block.

17. The method of claim 1 wherein updating the content block includes examining the content of all related content blocks in all related documents.

18. The method of claim 17 wherein updating the content block comprises:
keeping the original content block;
adding the update to the original content block; and
providing the content block as a version of the content block including the original content block and the update.

19. A computer program product, tangibly embodied in an information carrier, for evidence-based risk management, the computer program product being operable to cause data processing apparatus to:
receive medical evidence;
determine a set of related medical activities based on the medical evidence;
provide a set of tools, each tool corresponding to at least one of the medical activities in the set;
identify a set of content blocks in each tool in the tool set, including identifying content blocks that are common to at least two tools;
determine a medical condition of a patient; and
select a first tool from the tool set based on the medical condition.

20. The computer program product of claim 19 further being operable to cause data processing apparatus to update the first tool based on at least one other tool, the update occurring in at least one content block;

21. The method of claim 20 wherein the update occurs in a content block common to at least two tools.
